(19) United States
(12) Patent Application Publication
(10) Pub. No.: US 2007/0064862 A1
(43) Pub. Date: Mar. 22, 2007

(54) Pressurized water nuclear reactor fuel assembly including rods having two different contents of gadolinium

(76) Inventors: Patrice Belvegue, Sainte Anne Sur Gervonde (FR); Songhui Zheng, Chassieu (FR)

Correspondence Address: KENYON & KENYON LLP, ONE BROADWAY, NEW YORK, NY, 10004, US

(21) Appl. No.: 10/574,050

(22) PCT Filed: Sep. 22, 2004
(86) PCT No.: PCT/FR04/02387

§ 371 Date: Mar. 29, 2006

(30) Foreign Application Priority Data
Oct. 1, 2003 (EP) 03292424.3

(51) Int. Cl. G21C 3/00

(52) U.S. Cl. 376/419

(57) ABSTRACT

This fuel assembly for a pressurized water nuclear reactor includes nuclear fuel first rods having a first content by weight of gadolinium, and second nuclear fuel rods having a second content by weight of gadolinium. The second content is greater than the first content. The first content by weight is strictly greater than 2%.

### FIELD OF THE INVENTION

The present invention relates to fuel assemblies for a pressurized water nuclear reactor, the assembly including first nuclear fuel rods having a first content by weight of gadolinium, and second nuclear fuel rods having a second content by weight of gadolinium, the second content being greater than the first content.

### BACKGROUND INFORMATION

Gadolinium is a neutron poison which, when used in nuclear fuel assemblies, performs two functions. Firstly, it enables the initial reactivity of the core to be reduced after it has been refilled completely or in part with new fuel assemblies, because it absorbs neutrons. The progressive disappearance of the gadolinium compensates for the progressive exhaustion of the fuel.

Secondly, by using a suitable distribution of fuel assemblies containing gadolinium within the core of the nuclear reactor, it is possible to achieve a radial distribution of power that is more regular, with this continuing throughout the operating cycle of the core prior to reloading.

Initially, nuclear fuel assemblies were used in which the poisoned rods all had the same content by weight of gadolinium oxide (Gd₂O₃), generally lying in the range 5% to 12%.

Nevertheless, it has been found that such assemblies do not enable cores to be managed in satisfactory manner over utilization cycles of long duration, in particular longer than 18 months or 24 months.

Patent EP 0 799 484 then proposed an assembly having two different contents by weight of gadolinium oxide. That document relied on the observation that the initial anti-reactivity provided by the gadolinium is not proportional to its content, but increases much more slowly with content once the content exceeds about 1%.

That document therefore teaches using first rods with a first content by weight of gadolinium oxide lying in the range 0.5% to 2%, and second rods with the second content by weight lying in the range 5% to 12%. The first rods serve to reduce the initial reactivity in satisfactory manner. In addition, because of their low content, their anti-reactivity decreases very quickly from the beginning of the reactor cycle, such that the first rods do not impede the radial distribution of power during the remainder of the cycle, which distribution can then be controlled by the second poisoned rods.

However, it has been found that such fuel assemblies do not provide completely satisfactory management of cores for which the utilization cycles are particularly lengthy.

In particular, such assemblies lead to negative temperature coefficients of the moderator that are too small in absolute value.

It is recalled that this coefficient measures the increase in the capacity of the moderator, i.e. the cooling water flowing through the primary circuit of the reactor, to absorb neutrons when the temperature increases in the core. This coefficient, so to speak, measures the capacity of the core to shut itself down.

In addition, it has been found that the radial power peaking factor Fxy can rise during the cycle to above its initial value, i.e. its value at the beginning of the cycle.

It is recalled that the radial power peaking factor Fxy is the ratio of the maximum power emitted by a rod in the core and the mean power emitted by the rods in the core. This factor measures the power unbalance that exists between the rods in the core.

Such increases in the factor Fxy above its initial value complicate the management constraints on the operators of reactors who find it more comfortable for the maximum unbalance to be reached at the beginning of a cycle.

### SUMMARY

An objective of the invention is to solve these problems by making the management of pressurized water nuclear reactor cores safer and simpler.

To this end, the invention provides a fuel assembly for a pressurized water nuclear reactor, the assembly comprising first nuclear fuel rods having a first content by weight of gadolinium, and second nuclear fuel rods having a second content by weight of gadolinium, the second content being greater than the first content, the assembly being characterized in that the first content by weight is strictly greater than 2%.

In particular embodiments, the assembly may comprise one or more of the following characteristics taken in isolation or in any technically feasible combination:
the first content by weight is greater than or equal to 2.1%;
the first content by weight is greater than or equal to 2.2%;
the first content by weight is greater than or equal to 2.5%;
the first content by weight is greater than or equal to 3%;
the first content by weight is greater than or equal to 4%;
the first content by weight is greater than or equal to 5%; and
the first content by weight is greater than or equal to 8%.

### BRIEF DESCRIPTION OF THE DRAWINGS

The invention can be better understood on reading the following description given purely by way of example and made with reference to the accompanying drawings, in which:

FIG. 1 is a diagrammatic plan view showing the distribution of fuel rods in a first type of assembly in accordance with the invention;

FIG. 2 shows the variation in the anti-reactivity of a rod as a function of its gadolinium content in two assemblies, respectively having oxide fuel enriched with uranium 235 to 4.50% (continuous line curve) and to 3.90% (dashed line curve);

FIG. 3 is a view analogous to FIG. 1 showing a second type of assembly in accordance with the invention; and

FIG. 4 is a diagram showing one possible distribution of the assemblies of FIGS. 1 and 3 occupying one fourth of the core of a nuclear reactor.

### DETAILED DESCRIPTION

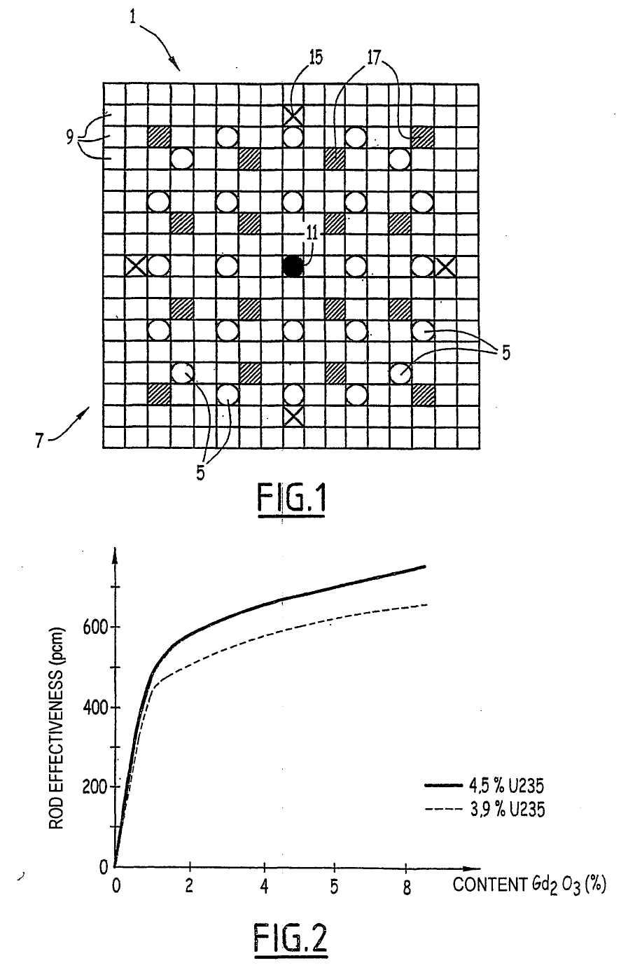

FIG. 1 illustrates a first type of assembly 1 for a pressurized water nuclear reactor (PWR).

The general structure of this assembly 1 is conventional and is therefore not described in detail. It is merely recalled that the assembly 1 comprises nuclear fuel rods and a support skeleton for holding these nuclear fuel rods at the nodes of a regular array, typically having a square base.

The skeleton has a bottom nozzle, a top nozzle, and guide tubes 5 interconnecting the two nozzles and designed to receive the rods of a cluster for controlling the operation of the core of the nuclear reactor.

The skeleton further comprises grids 7 for holding nuclear fuel rods. These grids 7 conventionally comprise crossed sets of plates defining between them cells 9 centered on the nodes of the regular array. Each cell 9 is designed to receive a fuel rod, most of which are not shown in FIG. 1, or a guide tube 5, the central cell 9 receiving an instrumentation tube 11.

In the example of FIG. 1, the holding grids 7 comprise 17 cells 9 per side. In other variants, the number of cells may be different, for example 14×14 or 15×15.

The cells 9 that are shown empty in FIG. 1, in fact contain nuclear fuel rods without gadolinium. Typically, these fuel rods contain uranium oxide enriched with isotope 235 to 2.5% by weight.

In addition to these non-poisoned fuel rods, the fuel assembly 1 includes poisoned nuclear fuel rods.

More precisely, it includes four first rods 15 having a first concentration by weight of gadolinium oxide, and 16 second rods 17 at a second concentration by weight of gadolinium oxide that is higher than the first concentration. The first rods 15 are identified by crosses and the second rods are identified by shading.

As set out in patent EP 0 799 484, and as shown in accompanying FIG. 2, the initial effectiveness of a rod containing gadolinium does not vary linearly with the numerical value of its content by weight of gadolinium oxide.

For example, it can be seen in FIG. 2 that for a rod initially enriched with uranium 235 to 4.50%, the anti-reactivity provided by 1% gadolinium is a little more than 500 parts per hundred thousand (pcm), whereas the anti-reactivity provided by 8% of gadolinium is only about 750 pcm. Reducing the initial gadolinium content by a ratio of 8 to 1 therefore leads to a reduction in anti-reactivity in a ratio of only 1.5 to 1, approximately. The dashed line curve shows that the same applies when using 3.9% enrichment with uranium 235. Similar behavior can also be observed when enriching with different concentrations of uranium 235, for example contents of uranium 235 of 2.5%.

That is why patent EP 0 799 484 teaches using a first content of gadolinium by weight that that is less than 2%.

Contrary to that teaching, the first gadolinium oxide (Gd₂O₃) content in this case is 5% by weight, and the second content is 10% by weight. The rods 15 and 17 are also enriched with uranium 235 to 2.5% by weight.

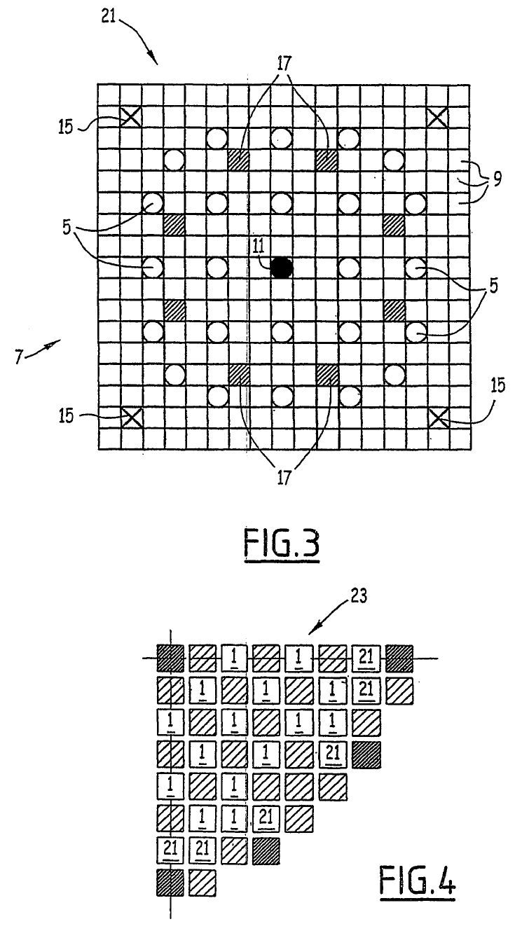

Numerical simulations have shown that the assembly 1 of FIG. 1 enables a nuclear reactor core to be managed more simply and more reliably. For this purpose, the operation of a core has been simulated when loaded with assemblies 1 of the first type, and also with assemblies 21 of a second type as shown in FIG. 3.

Unlike the assemblies 1 of the first type, these assemblies 21 include only 8 rods 17. The distribution of the rods 15 and 17 in the assemblies 21 is shown in FIG. 3.

FIG. 4 illustrates one fourth of the core 23 of the nuclear reactor, and it can be seen that it presents symmetry of order 4. The two axes of symmetry are shown in chain-dotted lines in FIG. 4.

Thus, the total structure of the core 23 can be deduced from FIG. 4 on its own.

The white squares represent the assemblies that were renewed at the beginning of the cycle and that are assemblies 1 of the first type and assemblies 21 of the second type. It can be seen that the assemblies 21 are disposed at the periphery of the core. In all, the core 23 has 52 assemblies 1 and 20 assemblies 21.

The lightly shaded squares represent assemblies that have already been subjected to one cycle and that are about to begin their second cycle.

The more darkly shaded squares correspond to assemblies that have already been subjected to two cycles and that are about to begin their third and last cycle.

The core 23 makes it possible to run a cycle that is relatively long, typically having a length of about 488 full power equivalent days (fped).

At the beginning of the cycle, the radial power peaking factor Fxy has a value of about 1.465 and the temperature coefficient of the moderator is −3.7 pcm/° C.

The initial value of the factor Fxy is thus particularly high, and considerably greater than with assemblies in accordance with the teaching of patent EP 0 799 484.

In addition, the time needed to exhaust the gadolinium from the first rods 15 is longer than is the case with patent EP-0 799 484.

Thus, the rise in the factor Fxy during the cycle will take place later on and will be of an amplitude that is much lower compared with the initial value of the radial power peaking factor Fxy.

These two effects are due to the first content in the first rods 15 that is strictly greater than 2%, thus making it possible, in particular, to benefit from poisoning by the first rods 15 that is of relatively long duration.

Thus, the core 23 is simpler to operate since the maximum value of the radial power peaking factor Fxy appears in more certain manner at the beginning of the cycle.

Similarly, the temperature coefficient of the moderator is very low, i.e. it possesses a high absolute value, thus guaranteeing increased safety in the operation of the core 23, without requiring a high initial concentration of boron in the coolant flowing through the primary circuit.

More generally, the invention can be implemented by using as the first content by weight in gadolinium oxide (Gd₂O₃) values that are strictly greater than 2%, for example 2.1%, 2.2%, 2.5%, 3%, 4%, 5%, 6%, 7%, 8%, or even more.

It has been found that the best results are obtained with values lying in the range 4% to 6%.

The second content in gadolinium oxide (Gd₂O₃), which is greater than the first content, may lie for example in the range 5% to 15%. It may thus be 5%, 6%, 7%, 8%, 9%, 10%, 11%, 12%, 13%, 14%, or 15%.

It is also possible for the number of rods 15 and 17 to be different from the numbers described above. Thus, for example, it is possible to use assemblies 1 including 8 rods 15 and 12 rods 17, assemblies 21 with 8 rods 15 and 8 rods 17, possibly together with other assemblies having 8 rods 15 and 4 rods 17.

In general, the number and the disposition of gadolinium-containing assemblies in the core 23 may be different from that shown in FIG. 4.

Similarly, the content in uranium 235 of the gadolinium-containing rods 15 and 17 may be different from that of the rods that do not contain any gadolinium, and for example may be smaller.

More generally, the nuclear fuel may comprise uranium oxide enriched in isotope 235 and/or in plutonium.

1-8. (canceled)

9. A fuel assembly for a pressurized water nuclear reactor, the assembly comprising:
first nuclear fuel rods having a first content by weight of gadolinium; and
second nuclear fuel rods having a second content by weight of gadolinium, the second content being greater than the first content, wherein the first content by weight is greater than 2%.

10. The assembly according to claim 1, wherein the first content by weight is one of greater than and equal to 2.1%.

11. The assembly according to claim 1, wherein the first content by weight is one of greater than and equal to 2.2%.

12. The assembly according to claim 1, wherein the first content by weight is one of greater than and equal to 2.5%.

13. The assembly according to claim 1, wherein the first content by weight is one of greater than and equal to 3%.

14. The assembly according to claim 1, wherein the first content by weight is one of greater than and equal to 4%.

15. The assembly according to claim 1, wherein the first content by weight is one of greater than and equal to 5%.

16. The assembly according to claim 1, wherein the first content by weight is one of greater than and equal to 8%.
